(19) United States
(12) Patent Application Publication
(10) Pub. No.: US 2022/0254169 A1
(43) Pub. Date: Aug. 11, 2022

(54) ROAD SURFACE INSPECTION APPARATUS, ROAD SURFACE INSPECTION METHOD, AND PROGRAM

(71) Applicant: NEC Corporation, Minato-ku, Tokyo (JP)

(72) Inventors: Kenichi YAMASAKI, Tokyo (JP); Gaku NAKANO, Tokyo (JP); Shinichiro SUMI, Tokyo (JP)

(73) Assignee: NEC Corporation, Minato-ku, Tokyo (JP)

(21) Appl. No.: 17/620,180

(22) PCT Filed: Jun. 28, 2019
(86) PCT No.: PCT/JP2019/025950

§ 371 Date: Dec. 17, 2021

(51) Int. Cl. G06V 20/56; G06T 7/11

(52) U.S. Cl. CPC G06V 20/588; G06N 20/00; G06T 7/11

(57) ABSTRACT

A road surface inspection apparatus (10) includes an image acquisition unit (110), a damage detection unit (120), and an output unit (130). The image acquisition unit (110) acquires an input image in which a road is captured. The damage detection unit (120) detects a damaged part of the road in the input image by using a damage determiner (122) being built by machine learning and determining a damaged part of a road. The output unit (130) outputs, to a display apparatus (30), a determination result with a certainty factor equal to or less than a reference value in a state of being distinguishable from another determination result out of one or more determination results of a damaged part of a road by the damage determiner (122).

### TECHNICAL FIELD

The present invention relates to a technology for supporting administration work of constructed roads.

### BACKGROUND ART

A road degrades by vehicle traffic, a lapse of time, and the like. Consequently, damage to the surface of the road may occur. Leaving damage to a road untouched may cause an accident. Therefore, a road needs to be periodically checked.

PTL 1 below discloses an example of a technology for efficiently checking a road. PTL 1 below discloses an example of a technology for detecting damage to a road surface (such as a crack or a rut) by using an image of the road.

### CITATION LIST

### Patent Literature

PTL 1: Japanese Patent Application Publication No. 2018-021375

### SUMMARY OF INVENTION

### Technical Problem

When damage to a road surface is detected by using an image of the road, higher precision in detection is preferable. Under the present conditions, precision is enhanced by the human eye confirming a determination result of damage to a road made by a computer. However, it is very time-consuming to confirm every determination result in every image by the human eye. A technology for enhancing precision of a determination result of damage to a road made by a computer while reducing human workloads is desired.

The present invention has been made in view of the problem described above. An object of the present invention is to provide a technology for enhancing precision of a determination result of damage to a road made by a computer while reducing human workloads.

### Solution to Problem

A first road surface inspection apparatus according to the present invention includes:

an image acquisition unit that acquires an input image in which a road is captured;

a damage detection unit that detects a damaged part of the road in the input image by using a damage determiner being built by machine learning and determining a damaged part of a road; and

an output unit that outputs, out of one or more determination results of a damaged part of the road by the damage determiner, the determination result with a certainty factor equal to or less than a reference value in a state of being distinguishable from another determination result to a display apparatus.

A second road surface inspection apparatus according to the present invention includes:

an image acquisition unit that acquires an input image in which a road is captured;

a damage detection unit that detects a damaged part of the road in the input image by using a damage determiner being built by machine learning and determining a damaged part of a road; and

an output unit that outputs, to a display apparatus, a determination result of a damaged part of the road by the damage determiner along with a certainty factor of the determination result.

A first road surface inspection method according to the present invention includes, by a computer:

acquiring an input image in which a road is captured;

detecting a damaged part of the road in the input image by using a damage determiner being built by machine learning and determining a damaged part of a road; and

outputting, out of one or more determination results of a damaged part of the road by the damage determiner, the determination result with a certainty factor equal to or less than a reference value in a state of being distinguishable from another determination result to a display apparatus.

A second road surface inspection method according to the present invention includes, by a computer:

acquiring an input image in which a road is captured;

detecting a damaged part of the road in the input image by using a damage determiner being built by machine learning and determining a damaged part of a road; and

outputting, to a display apparatus, a determination result of a damaged part of the road by the damage determiner along with a certainty factor of the determination result.

A program according to the present invention causes a computer to execute the aforementioned first road surface inspection method or second road surface inspection method.

### Advantageous Effects of Invention

The present invention provides a technology for enhancing precision of a determination result of damage to a road by a computer while reducing human workloads.

### BRIEF DESCRIPTION OF DRAWINGS

The aforementioned object, other objects, features and advantages will become more apparent by use of the following preferred example embodiments and accompanying drawings.

FIG. 1 is a diagram illustrating a functional configuration of a road surface inspection apparatus according to a first example embodiment.

FIG. 2 is a block diagram illustrating a hardware configuration of the road surface inspection apparatus.

FIG. 3 is a flowchart illustrating a flow of processing executed by the road surface inspection apparatus according to the first example embodiment.

FIG. 4 is a diagram illustrating an example of a screen output to a display apparatus by an output unit.

FIG. 5 is a diagram illustrating another example of a screen output to the display apparatus by the output unit.

FIG. 6 is a diagram illustrating another example of a screen output to the display apparatus by the output unit.

FIG. 7 is a diagram illustrating a functional configuration of a road surface inspection apparatus according to a second example embodiment.

FIG. 8 is a flowchart illustrating a flow of processing executed by the road surface inspection apparatus according to the second example embodiment.

FIG. 9 is a diagram illustrating a specific operation of a damage determination result correction unit.

FIG. 10 is a diagram illustrating the specific operation of the damage determination result correction unit.

FIG. 11 is a diagram illustrating a functional configuration of a road surface inspection apparatus according to a third example embodiment.

FIG. 12 is a flowchart illustrating a flow of processing executed by the road surface inspection apparatus according to the third example embodiment.

FIG. 13 is a diagram illustrating an example of a screen output to a display apparatus by an output unit according to the third example embodiment.

FIG. 14 is a diagram illustrating a functional configuration of a road surface inspection apparatus according to a fourth example embodiment.

FIG. 15 is a flowchart illustrating a flow of processing executed by the road surface inspection apparatus according to the fourth example embodiment.

FIG. 16 is a diagram illustrating a specific operation of a segment determination result correction unit.

FIG. 17 is a diagram illustrating the specific operation of the segment determination result correction unit.

FIG. 18 is a block diagram illustrating a functional configuration of a road surface inspection apparatus according to a fifth example embodiment.

FIG. 19 is a diagram for illustrating a specific operation of a learning unit.

FIG. 20 is a diagram illustrating another example of a screen output to the display apparatus by the output unit.

FIG. 21 is a diagram illustrating another example of a screen output to the display apparatus by the output unit.

FIG. 22 is a diagram illustrating a specific operation of the damage determination result correction unit.

FIG. 23 is a diagram illustrating the specific operation of the damage determination result correction unit.

### EXAMPLE EMBODIMENTS

Example embodiments of the present invention will be described below by using drawings. In every drawing, similar components are given similar signs, and description thereof is not repeated as appropriate. Further, unless otherwise described, each block in each block diagram represents a function-based configuration rather than a hardware-based configuration. Further, a direction of an arrow in a diagram is for facilitating understanding of an information flow and does not limit a direction of communication (unidirectional communication/bidirectional communication) unless otherwise described.

### First Example Embodiment

### <Functional Configuration>

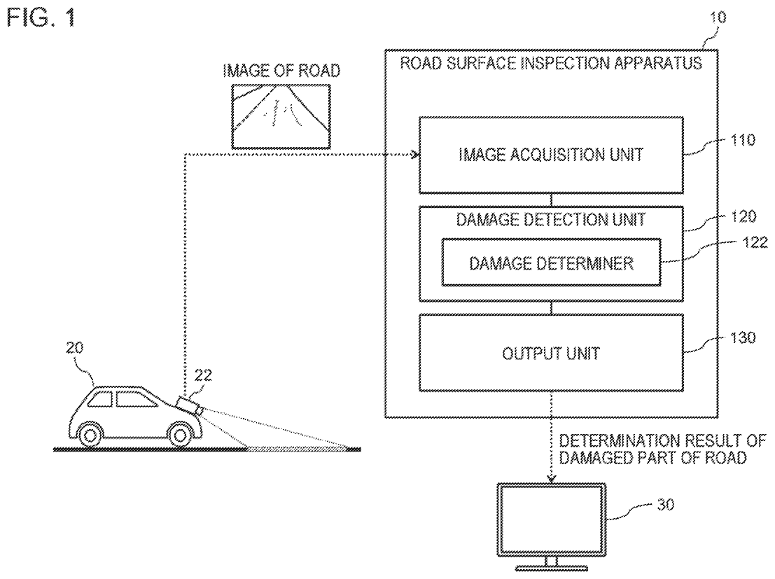

FIG. 1 is a diagram illustrating a functional configuration of a road surface inspection apparatus according to a first example embodiment. The road surface inspection apparatus 10 illustrated in FIG. 1 includes an image acquisition unit 110, a damage detection unit 120, and an output unit 130.

The image acquisition unit 110 acquires an input image in which a road surface being a checking target is captured. As illustrated in FIG. 1, an image of a road surface is generated by an image capture apparatus 22 equipped on a vehicle 20. Specifically, a road surface video of a road in a checking target section is generated by the image capture apparatus 22 performing an image capture operation while the vehicle 20 travels on the road in the checking target section. The image acquisition unit 110 acquires at least one of a plurality of frame images constituting the road surface video as an image being a target of image processing (analysis). When the image capture apparatus 22 has a function of connecting to a network such as the Internet, the image acquisition unit 110 may acquire an image of a road surface from the image capture apparatus 22 through the network. Further, the image capture apparatus 22 having the network connection function may be configured to transmit a road surface video to a video database, which is unillustrated, and the image acquisition unit 110 may be configured to acquire the road surface video by accessing the video database. Further, for example, the image acquisition unit 110 may acquire a road surface video from the image capture apparatus 22 connected by a communication cable or a portable storage medium such as a memory card.

The damage detection unit 120 detects a damaged part of a road in an input image acquired by the image acquisition unit 110, by using a damage determiner 122. The damage determiner 122 is built to be able to determine a damaged part of a road from an input image by repeating machine learning by using learning data combining an image of a road with information indicating a damaged part of the road (a correct answer label). For example, learning data used when the damage determiner 122 is initially built are generated by a person in charge of data analysis performing work of assigning a suitable correct answer label to a learning image. For example, the damage determiner 122 is modeled, by machine learning, to detect a crack, a rut, a pothole, a subsidence, a dip, or a step caused on a road surface as a damaged part of the road.

The output unit 130 outputs a determination result of a damaged part of a road by the damage determiner 122 to a display apparatus 30. The output unit 130 outputs, to the display apparatus 30, a determination result with a certainty factor equal to or less than a reference value in a state of being distinguishable from another determination result (a determination result with a certainty factor exceeding the reference value) out of one or more determination results of a damaged part of a road by the damage determiner 122. The certainty factor refers to information indicating reliability of a determination result of damage by the damage determiner 122. As an example, the certainty factor is represented by a binary value of 0 (a low certainty factor) or 1 (a high certainty factor), or a continuous value in a range from 0 to 1. For example, the damage determiner 122 may compute a degree of similarity between a feature value of a damaged part of a road acquired by machine learning and a feature value acquired from a damaged part (pixel region) captured in an input image as a certainty factor of a determination result.

### <Hardware Configuration Example>

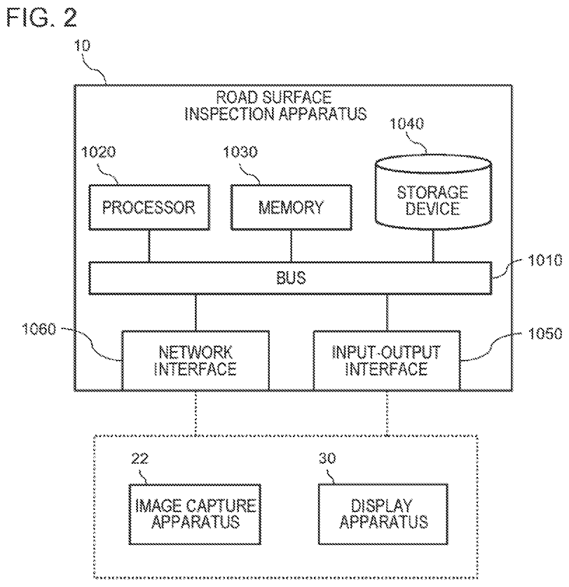

Each functional component in the road surface inspection apparatus 10 may be provided by hardware (such as a hardwired electronic circuit) providing the functional component or may be provided by a combination of hardware and software (such as a combination of an electronic circuit and a program controlling the circuit). The case of providing each functional component in the road surface inspection apparatus 10 by a combination of hardware and software will be further described by using FIG. 2. FIG. 2 is a block diagram illustrating a hardware configuration of the road surface inspection apparatus 10.

The road surface inspection apparatus 10 includes a bus 1010, a processor 1020, a memory 1030, a storage device 1040, an input-output interface 1050, and a network interface 1060.

The bus 1010 is a data transmission channel for the processor 1020, the memory 1030, the storage device 1040, the input-output interface 1050, and the network interface 1060 to transmit and receive data to and from one another. Note that a method for interconnecting the processor 1020 and other components is not limited to a bus connection.

The processor 1020 is a processor configured with a central processing unit (CPU), a graphics processing unit (GPU), or the like.

The memory 1030 is a main storage configured with a random access memory (RAM) or the like.

The storage device 1040 is an auxiliary storage configured with a hard disk drive (HDD), a solid state drive (SSD), a memory card, a read only memory (ROM), or the like. The storage device 1040 stores a program module implementing each function of the road surface inspection apparatus 10 (such as the image acquisition unit 110, the damage detection unit 120, or the output unit 130). By the processor 1020 reading each program module into the memory 1030 and executing the program module, each function related to the program module is provided.

The input-output interface 1050 is an interface for connecting the road surface inspection apparatus 10 to various input-output devices. The input-output interface 1050 may be connected to input apparatuses (unillustrated) such as a keyboard and a mouse, output apparatuses (unillustrated) such as a display and a printer, and the like. Further, the input-output interface 1050 may be connected to the image capture apparatus 22 (or a portable storage medium equipped on the image capture apparatus 22) and the display apparatus 30. The road surface inspection apparatus 10 can acquire a road surface video generated by the image capture apparatus 22 by communicating with the image capture apparatus 22 (or the portable storage medium equipped on the image capture apparatus 22) through the input-output interface 1050. Further, the road surface inspection apparatus 10 can output a screen generated by the output unit 130 to the display apparatus 30 connected through the input-output interface 1050.

The network interface 1060 is an interface for connecting the road surface inspection apparatus 10 to a network. Examples of the network include a local area network (LAN) and a wide area network (WAN). The method for connecting the network interface 1060 to the network may be a wireless connection or a wired connection. The road surface inspection apparatus 10 can acquire a road surface video generated by the image capture apparatus 22 by communicating with the image capture apparatus 22 or a video database, which is unillustrated, through the network interface 1060. Further, the road surface inspection apparatus 10 can cause the display apparatus 30 to display a screen generated by the output unit 130 by communicating with the display apparatus 30 through the network interface 1060.

Note that the hardware configuration of the road surface inspection apparatus 10 is not limited to the configuration illustrated in FIG. 2.

### <Flow of Processing>

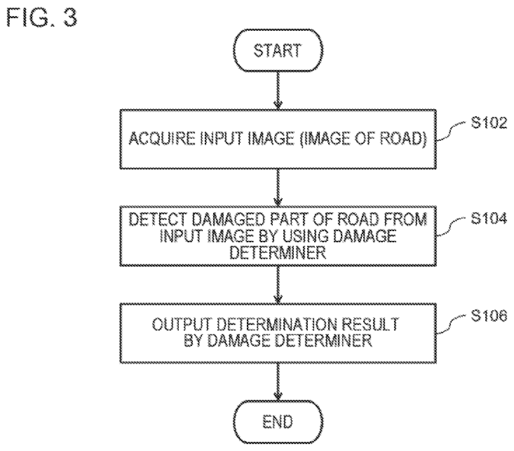

FIG. 3 is a flowchart illustrating a flow of processing executed by the road surface inspection apparatus 10 according to the first example embodiment.

First, the image acquisition unit 110 acquires an input image (an image of a road to be a processing target) (S102). For example, the image acquisition unit 110 acquires a road surface video generated by the image capture apparatus 22 through the input-output interface 1050 or the network interface 1060. Then, the image acquisition unit 110 reads a plurality of frame images constituting the road surface video in whole or in part as images of the processing target road. The image acquisition unit 110 may be configured to execute preprocessing on the road image in order to improve processing efficiency in a downstream step. For example, the image acquisition unit 110 may execute preprocessing such as front correction processing or deblurring processing on the road image.

Next, the damage detection unit 120 detects a damaged part of the road from the input image by using the damage determiner 122 (S104). The damage detection unit 120 acquires, from the damage determiner 122, information indicating a position determined to be the damage to the road (the damaged part of the road) in the input image and information indicating a certainty factor related to the determination. As an example, the damage determiner 122 determines a pixel region having a degree of similarity to a feature value of a damaged part of a road acquired by machine learning at a certain level or higher to be a damaged part of the road and outputs the determination result. At this time, the damage determiner 122 outputs a degree of similarity of feature value computed from the feature value of the damaged part of the road acquired by the machine learning and a feature value extracted from the pixel region determined to be the damaged part of the road as a certainty factor of the determination result. The damage detection unit 120 acquires the pieces of information as a “determination result of a damaged part of the road by the damage determiner 122.”

Next, the output unit 130 outputs the determination result of a damaged part of the road by the damage determiner 122 (S106). The output unit 130 determines whether the determination results of a damaged part of the road by the damage determiner 122 include a determination result with a certainty factor equal to or less than a reference value. For example, by comparing a certainty factor of each determination result of a damaged part of the road by the damage determiner 122 with a preset reference value, the output unit 130 determines a determination result with a certainty factor equal to or less than the reference value (specifically, a pixel region corresponding to a determination result with a certainty factor equal to or less than the reference value). Then, when the determination results of a damaged part of the road by the damage determiner 122 include a determination result with a certainty factor equal to or less than the reference value, the output unit 130 outputs, to the display apparatus 30, the determination result in a state of being distinguishable from another determination result. A screen output to the display apparatus 30 by the output unit 130 will be exemplified below.

### <<Example of Output Screen>>

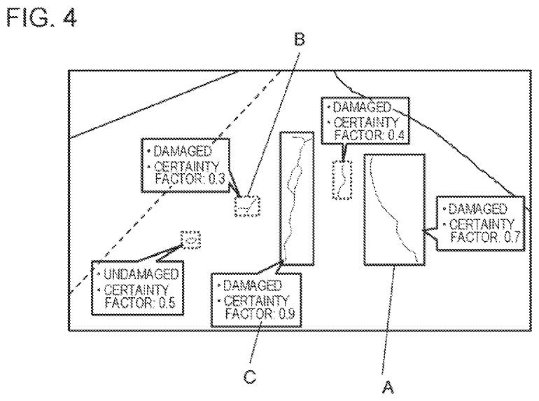

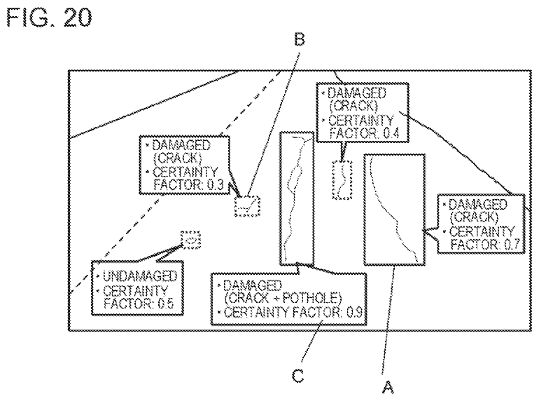

FIG. 4 is a diagram illustrating an example of a screen output to the display apparatus 30 by the output unit 130. In the screen illustrated in FIG. 4, the output unit 130 makes a determination result with a certainty factor equal to or less than the reference value distinguishable from another determination result with a certainty factor exceeding the reference value by a display mode of a specific display element (rectangular frame). Specifically, the output unit 130 assigns a solid-lined rectangular frame A to a part determined to be a “damaged road” with a certainty factor exceeding the reference value. Further, the output unit 130 assigns a dot-lined rectangular frame B to a part determined to be a “damaged road” or an “undamaged road” with a certainty factor equal to or less than the reference value. Note that the output unit 130 does not assign a specific display element such as a rectangular frame to a part determined to be an “undamaged road” with a certainty factor equal to or greater than the reference value. The screen illustrated in FIG. 4 enables at-a-glance identification of a result determined with a low certainty factor (that is, a determination result to be confirmed by the human eye) out of determination results of damage to the road by the damage determiner 122. Further, in the screen illustrated in FIG. 4, the output unit 130 further outputs character information C indicating a determination result of whether the part is a damaged part of the road and a certainty factor of the determination result. By enabling visual recognition of the magnitude of a certainty factor of a determination result by the damage determiner 122, a person browsing the screen output to the display apparatus 30 can easily recognize a determination result with a high probability of error (that is, a determination result to be confirmed with extra caution). Note that the output unit 130 may be configured to include information indicating the type of damage to a road (such as a crack or a pothole) in the character information C, as illustrated in FIG. 20. FIG. 20 is a diagram illustrating another example of a screen output to the display apparatus 30 by the output unit 130.

Note that the display mode enabling a determination result with a certainty factor equal to or less than the reference value to be distinguishable from another determination result is not limited to the example in FIG. 4. For example, the output unit 130 may be configured to switch the color of a frame outline, the thickness of the frame outline, and a fill pattern in the frame, based on whether a certainty factor related to a determination result is equal to or less than the reference value. Further, for example, the output unit 130 may be configured to set the color of a frame outline, the thickness of the frame outline, and a fill pattern in the frame according to a certainty factor related to a determination result. Further, the output unit 130 may use a display element other than a rectangular frame as a display element assigned to each determination result by the damage determiner 122. For example, in order to make a determination result with a certainty factor equal to or less than the reference value distinguishable from another determination result, the output unit 130 may use a display element emphasizing the shape of a damaged part (the shape of a crack or a pothole) of a road (such as a line emphasizing the external shape or a filling). Further, when some object not determined to be a “damaged part of a road” exists in a certain region as a result of determination by the damage determiner 122, the output unit 130 may output a display element emphasizing the shape of the object (such as a line emphasizing the external shape or a filling).

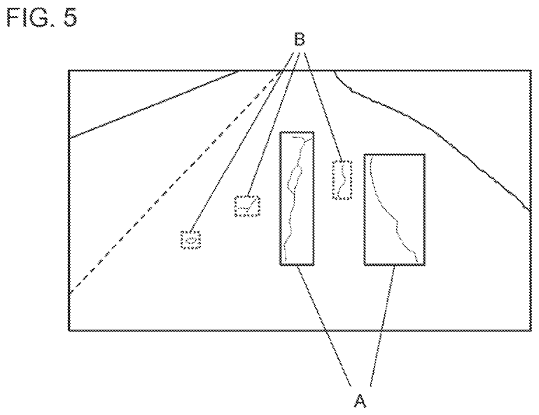

Further, for example, the output unit 130 may be configured to make a determination result with a low certainty factor distinguishable from another determination result by a specific display element such as a rectangular frame without displaying character information C (example: FIG. 5). FIG. 5 is a diagram illustrating another example of a screen output to the display apparatus 30 by the output unit 130. The screen illustrated in FIG. 5 also enables easy identification of a determination result with a low certainty factor by a display mode (solid line/dotted line) of a rectangular frame.

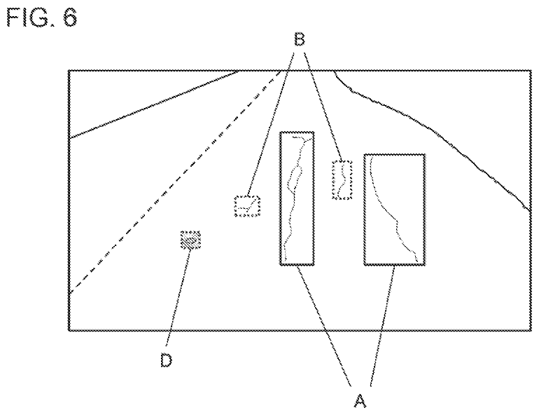

Further, the output unit 130 may change the display mode of a specific display element, based on a determination result (determination of damaged/undamaged) of a damaged part of the road and the certainty factor of the determination result (example: FIG. 6). FIG. 6 is a diagram illustrating another example of a screen output to the display apparatus 30 by the output unit 130. In the screen illustrated in FIG. 6, the output unit 130 assigns a solid-lined rectangular frame A to a part determined to be a “damaged road” with a certainty factor exceeding the reference value. Further, the output unit 130 assigns a dot-lined rectangular frame B to a part determined to be a “damaged road” with a certainty factor equal to or less than the reference value. Further, the output unit 130 assigns a dot-lined shaded rectangular frame D to a part determined to be an “undamaged road” with a certainty factor equal to or less than the reference value. Note that the output unit 130 does not assign a specific display element such as a rectangular frame to a part determined to be an “undamaged road” with a certainty factor equal to or greater than the reference value. The screen illustrated in FIG. 6 further enables identification of a part determined to be a “damaged road” with a certainty factor equal to or less than the reference value (that is, a part with a relatively high probability of erroneous detection) and a part determined to be an “undamaged road” with a certainty factor equal to or less than the reference value (that is, a part with a relatively high probability of omitted detection).

### Advantageous Effect

As described above, a determination result with a certainty factor equal to or less than a reference value (in other words, with a low certainty factor) can be identified on a screen outputting a result of determining a damaged part of a road out of an input image by using the damage determiner 122, according to the present example embodiment. It is considered that a determination result of a damaged part of a road by the damage determiner 122 having a “low certainty factor” means that the possibility of the determination result including an error (erroneous detection or omitted detection) is relatively high when viewed by the human eye. Therefore, with the configuration according to the present example embodiment enabling identification of a determination result with a low certainty factor, an effect of improving efficiency of work of confirming, with the human eye, existence of erroneous determination by the damage determiner 122 and reducing workloads as a whole can be expected.

### Modified Example

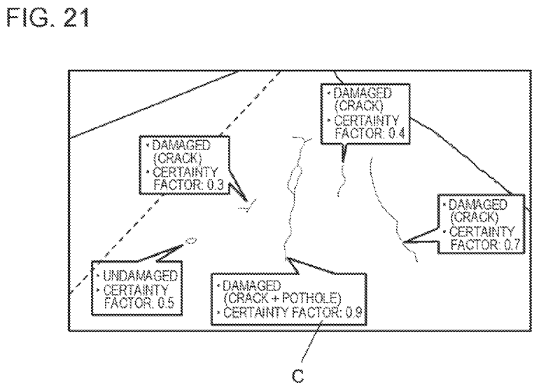

The output unit 130 according to the present example embodiment may be configured to output a determination result of a damaged part of a road by the damage determiner 122 along with the certainty factor of the determination result. For example, the output unit 130 is configured to, for each determination result of a damaged part of a road, output a display element (character information C) indicating the certainty factor of the determination result by the damage determiner 122, as illustrated in FIG. 21. FIG. 21 is a diagram illustrating another example of a screen output to the display apparatus 30 by the output unit 130. As illustrated in FIG. 21, by visualizing the magnitude of the certainty factor of a determination result by the damage determiner 122, a person browsing a screen output to the display apparatus 30 can easily recognize a determination result with a high probability of error (that is, a determination result to be confirmed with extra caution).

### Second Example Embodiment

When there is an error in a determination result by a machine (the damage determiner 122), a person confirming the error on a screen normally performs correction work. A road surface inspection apparatus 10 according to the present example embodiment differs from that according to the aforementioned first example embodiment in further including a configuration related to correction work as described below.

### <Functional Configuration Example>

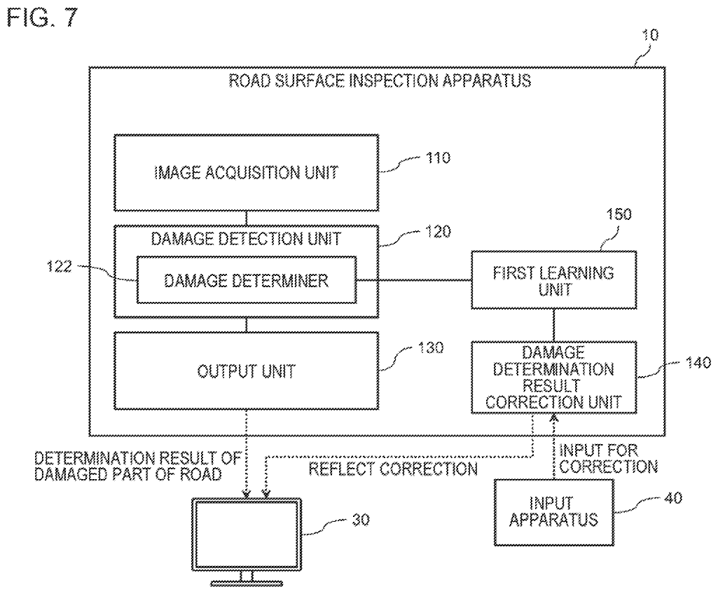

FIG. 7 is a diagram illustrating a functional configuration of the road surface inspection apparatus 10 according to the second example embodiment. The road surface inspection apparatus 10 according to the present example embodiment further includes a damage determination result correction unit 140 and a first learning unit 150.

Based on an input for correction to a determination result of a damaged part of a road, the determination result being output to a display apparatus 30, the damage determination result correction unit 140 corrects the determination result being a target of the input for correction. Specifically, a person performing confirmation work on a screen (a screen for displaying a determination result of a damaged part of a road by the damage determiner 122) output on the display apparatus 30 performs an input operation (input for correction) of correcting an erroneous determination result found on the screen to a correct determination result by using an input apparatus 40. The damage determination result correction unit 140 accepts the input for correction through the input apparatus 40. Then, the damage determination result correction unit 140 corrects the erroneous determination result, based on the input for correction. For example, when a person performs an operation of correcting a result determined to be “damaged” by the damage determiner 122 to a determination result of “undamaged,” the damage determination result correction unit 140 corrects the determination result being a target of the operation and updates display contents on the screen (reflects the correction).

Further, the first learning unit 150 generates training data for machine learning of the damage determiner 122 (first training data) by using an input for correction to a determination result of a damaged part and an input image. For example, the first learning unit 150 may extract a partial image region corresponding to a determination result being a target of an input for correction and generate first training data by combining the partial image region with a determination result indicated by the input for correction (a correct answer label indicating a damaged part/undamaged part of a road). Further, the first learning unit 150 may generate first training data by combining an input image acquired by an image acquisition unit 110 with a determination result of a damaged part of a road by the damage determiner 122. In this case, the determination result of a damaged part of the road by the damage determiner 122 may include a determination result corrected by the damage determination result correction unit 140 as a target of an input for correction and a determination result not being a target of the input for correction. Then, the first learning unit 150 performs learning (relearning) of the damage determiner 122 by using the generated first training data.

### <Flow of Processing>

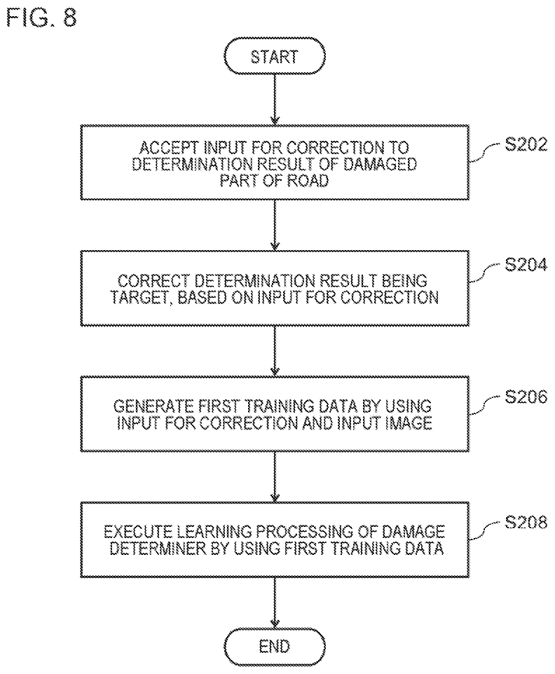

FIG. 8 is a flowchart illustrating a flow of processing executed by the road surface inspection apparatus 10 according to the second example embodiment. Processing described below is executed after output processing (such as the processing in S106 in FIG. 3) performed by an output unit 130.

First, the damage determination result correction unit 140 accepts an input for correction to a determination result of a damaged part of a road by the damage determiner 122 (S202). The input for correction is performed by a person performing confirmation work on a screen displayed on the display apparatus 30, by using the input apparatus 40 such as a keyboard, a mouse, or a touch panel. Then, based on the input for correction, the damage determination result correction unit 140 corrects the determination result being a target of the input for correction (S204).

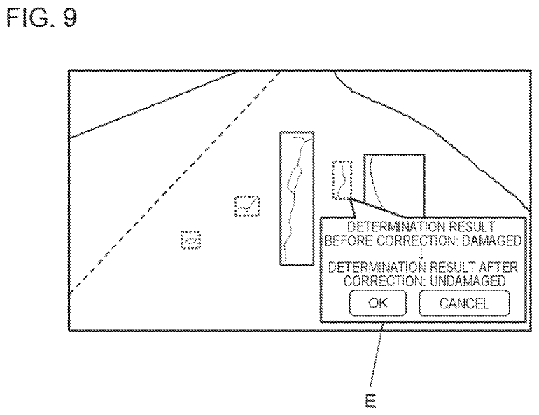

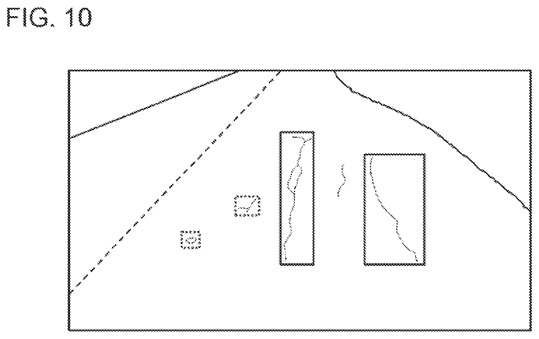

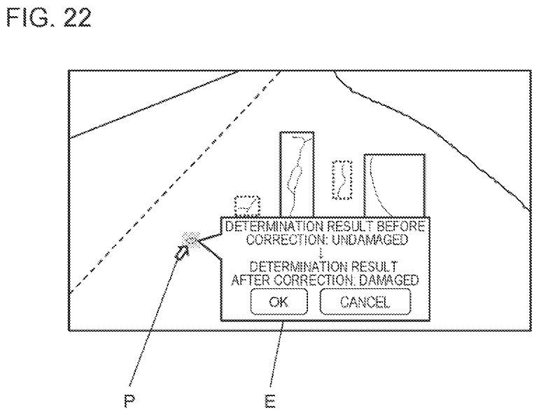

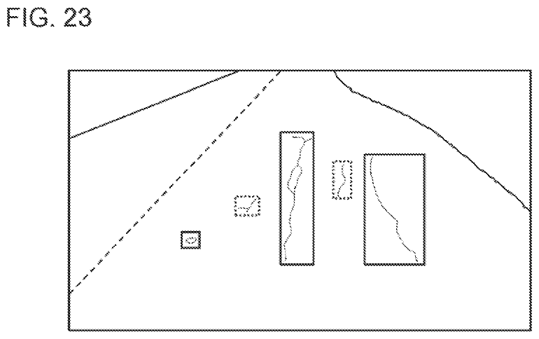

Specific examples of the operation performed by the damage determination result correction unit 140 will be described by using diagrams. FIG. 9, FIG. 10, FIG. 22, and FIG. 23 are diagrams illustrating specific operations of the damage determination result correction unit 140. Note that the diagrams are strictly examples, and the operation of the damage determination result correction unit 140 is not limited to contents disclosed in the diagrams.

First, when an error is found in a determination result displayed on the display apparatus 30, information for correction to the determination result is input through a user interface E as illustrated in FIG. 9 and FIG. 22. In the example in FIG. 9, input for correcting a determination of a “damaged road” made by the damage determiner 122 to “not a damaged road (undamaged)” is performed. When an “OK” button is depressed on the user interface E, the damage determination result correction unit 140 corrects the target determination result, based on the input on the user interface E. Consequently, for example, the display on the display apparatus 30 is updated as illustrated in FIG. 10. On a screen illustrated in FIG. 10, the spot being a target of the input for correction is specified (determined with a high certainty factor) to be an “undamaged part of the road” by the human, and therefore the damage determination result correction unit 140 sets the rectangular frame displayed at the part to non-display. Further, in the example in FIG. 22, input for correcting a determination of “not a damaged road (undamaged)” made by the damage determiner 122 to a “damaged road” is performed. In the example in this diagram, first, by operating a pointer P by using an input apparatus or the like, a user specifies the damaged part of the road undetected by the damage determiner 122 (the determination result of “not a damaged road (undamaged)” made by the damage determiner 122). Subsequently, the user performs input for correcting the specified part to a “damaged road.” For example, when an “OK” button is depressed on the user interface E on the screen illustrated in FIG. 22, the damage determination result correction unit 140 corrects the target determination result, based on the input on the user interface E. Consequently, for example, the display on the display apparatus 30 is updated as illustrated in FIG. 23. On the screen illustrated in FIG. 23, the spot being a target of the input for correction is specified (determined with a high certainty factor) to be a “damaged road” by the human, and therefore the damage determination result correction unit 140 updates the screen display in such a way that the rectangular frame displayed at the part is drawn in solid lines.

Returning to the flowchart in FIG. 8, the first learning unit 150 generates first training data by using the input for correction accepted in S202 and the input image acquired by the image acquisition unit 110 (S206). For example, the first learning unit 150 extracts, from the input image, a partial image related to the determination result being a target of correction by the input for correction and generates first training data by combining an image feature value of the partial image or the partial image with contents of the input for correction (information indicating a damaged/undamaged road). Then, the first learning unit 150 executes learning processing of the damage determiner 122 by using the generated first training data (S208). The first learning unit 150 may be configured to execute learning processing of the damage determiner 122 every time an input for correction is accepted. Further, the first learning unit 150 may be configured to accumulate first training data generated according to an input for correction into a predetermined storage region and execute learning processing using the accumulated first training data at a predetermined timing (such as a timing of periodic nighttime maintenance).

### <Example of Advantageous Effect>

As described above, when there is an error in a determination result of a damaged part of a road by the damage determiner 122, the present example embodiment enables correction of the error by a human determination. Further, according to the present example embodiment, training data for machine learning of the damage determiner 122 are generated according to an input for correction to a determination result of a damaged part of a road by the damage determiner 122, and relearning processing of the damage determiner 122 is executed by using the training data. Thus, the determination system of a damaged part of a road by the damage determiner 122 can be improved, and the number of appearances of a determination result with a low certainty factor (a determination result to be confirmed by the human) can be reduced. By reduction of the number of appearances of a determination result with a low certainty factor, further improvement in efficiency of the entire work can be expected. Further, according to the present example embodiment, work of correcting an erroneous determination of a damaged part of a road made by the damage determiner 122 also serves as work of generating training data for machine learning. Therefore, learning data for the damage determiner 122 can be generated in confirmation work of an output by the output unit 130 without separately performing conventional work of generating learning data (work of manually associating learning image data with a correct answer label). Thus, efforts made for improving precision of the damage determiner 122 can be reduced.

### Third Example Embodiment

The present example embodiment has a configuration similar to that in the aforementioned first example embodiment or second example embodiment except for a point described below.

### <Functional Configuration Example>

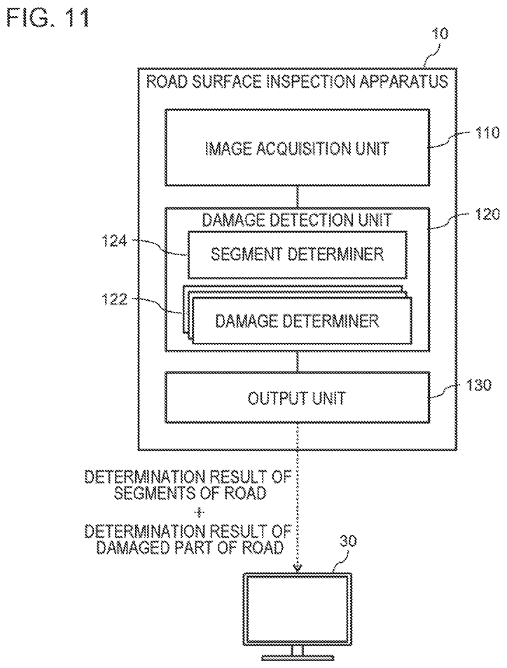

FIG. 11 is a diagram illustrating a functional configuration of a road surface inspection apparatus 10 according to the third example embodiment. As illustrated in FIG. 11, a plurality of segments are defined in a widthwise direction of a road, according to the present example embodiment. For example, the plurality of segments include a roadway, a shoulder, a sidewalk, and the ground adjacent to a road (a region outside a road and adjacent to the road). Then, the damage detection unit 120 includes a plurality of damage determiners 122 respectively related to the plurality of segments as described above. Each damage determiner 122 is built, by machine learning, to determine a damaged part in each of the plurality of segments set in a widthwise direction of a road. For example, one damage determiner 122 is built as a determiner dedicated to determination of a damaged part of a roadway by repeating machine learning by using training data combining a learning image with information (a correct answer label) indicating the position or the like of a damaged part of a roadway in the image. Further, another damage determiner 122 is built as a determiner dedicated to determination of a damaged part of a sidewalk by repeating machine learning by using training data combining a learning image with information (a correct answer label) indicating the position or the like of a damaged part of a sidewalk in the image. Further, machine learning is similarly performed on segments such as a shoulder and the ground adjacent to a road, and a damage determiner 122 dedicated to determination of a damaged part of each segment is built. The damage detection unit 120 according to the present example embodiment detects a damaged part of a road for each of the segments of the road as described above by using the plurality of damage determiners 122.

Further, the damage detection unit 120 according to the present example embodiment includes a segment determiner 124 determining a region corresponding to each of the plurality of segments defined in a widthwise direction of a road. By using the segment determiner 124, the damage detection unit 120 according to the present example embodiment determines a region corresponding to each of the aforementioned plurality of segments in an input image acquired by an image acquisition unit 110. The segment determiner 124 is built to be able to determine a region corresponding to each of the plurality of segments defined in the widthwise direction of the road from an image by repeating machine learning by using learning data combining an image of a road with information (a correct answer label) indicating a segment of the road captured in the image. Further, an output unit 130 according to the present example embodiment outputs a determination result of the aforementioned plurality of segments by the segment determiner 124 to a display apparatus 30 along with determination results of a damaged part of the road by the damage determiners 122.

Note that, while not being illustrated, the road surface inspection apparatus 10 according to the present example embodiment may further include the damage determination result correction unit 140 and the first learning unit 150 described in the second example embodiment.

### <Flow of Processing>

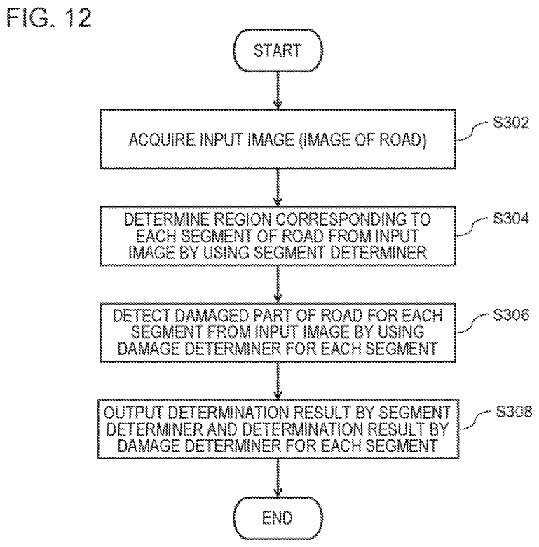

FIG. 12 is a flowchart illustrating a flow of processing executed by the road surface inspection apparatus 10 according to the third example embodiment.

First, the image acquisition unit 110 acquires an input image of a processing target (S302). The processing is similar to the processing in S102 in the flowchart in FIG. 3.

Next, by using the segment determiner 124, the damage detection unit 120 determines an image region corresponding to each segment of a road from the input image acquired by the image acquisition unit 110 (S304). Then, by using a damage determiner 122 related to a segment determined in the processing in S304, the damage detection unit 120 detects a damaged part of the road for each segment from the input image acquired by the image acquisition unit 110 (S306). At this time, the damage detection unit 120 may determine an image region of a segment related to each of the plurality of damage determiners 122 from the input image by using a determination result of each segment by the segment determiner 124 and set the determined image region to be an input to each of the plurality of damage determiners 122. Such a configuration enables improvement in precision of an output (a determination result of a damaged part of a road) of each of the plurality of damage determiners 122.

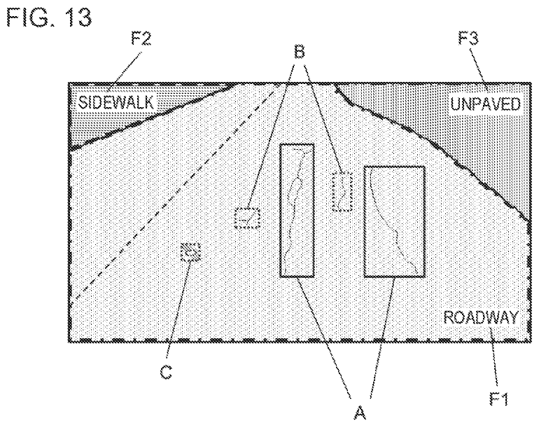

Then, the output unit 130 outputs, to the display apparatus 30, the determination result of segments of the road by the segment determiner 124, the determination result being acquired in the processing in S304, and the determination result of a damaged part of the road for each segment by the damage determiner 122 for each segment, the determination result being acquired in the processing in S306 (S308). For example, the output unit 130 outputs a screen as illustrated in FIG. 13 to the display apparatus 30. FIG. 13 is a diagram illustrating an example of a screen output to the display apparatus 30 by the output unit 130 according to the third example embodiment. In the screen illustrated in FIG. 13, the output unit 130 further outputs display elements F1 to F3 representing a determination result of segments of a road by the segment determiner 124, in addition to display elements A to C representing determination results of a damaged part of the road by a plurality of damage determiners 122.

### <Example of Advantageous Effect>

As described above, a determination result of segments of a road by the segment determiner 124 is further output through the display apparatus 30, according to the present example embodiment. Thus, a person can visually recognize how a machine (the road surface inspection apparatus 10) recognizes a road captured in an input image. Further, based on the determination result of segments of the road and a determination result of a damaged part of the road by the damage determiner 122 built for each segment of the road, a person can visually recognize how each damage determiner 122 determines a damaged part of the road. Thus, for example, when a determination result with a low certainty factor or an error in determination (omitted detection or erroneous detection) appears, a damage determiner 122 having a problem in precision out of the plurality of damage determiners 122 can be easily determined by the human eye.

### Modified Example

The plurality of damage determiners 122 according to the present example embodiment may be classified by road surface material such as “asphalt” and “concrete” instead of (or in addition to) by segment in a widthwise direction of a road such as a “roadway” and a “sidewalk.” In this case, the segment determiner 124 is built to be able to identify a road surface material of a road captured in an image instead of (or in addition to) a segment such as a roadway or a sidewalk. For example, the segment determiner 124 can learn a feature value for each road surface material of a road by repeating machine learning by using training data combining a road image for learning with a correct answer label indicating a road surface material in the image. The damage detection unit 120 determines existence of damage to a road surface by acquiring information indicating a road surface material of a road captured in a processing target image from the segment determiner 124 and selecting a damage determiner 122 related to the road surface material indicated by the information. With the configuration of this modified example, an optimum learning model (damage determiner 122) is selected according to the road surface material of a road captured in a processing target image, and therefore an effect of improving precision in detection of damage to a road surface can be expected.

### Fourth Example Embodiment

The present example embodiment has a configuration similar to that in the aforementioned first example embodiment, second example embodiment, or third example embodiment except for a point described below.

### <Functional Configuration Example>

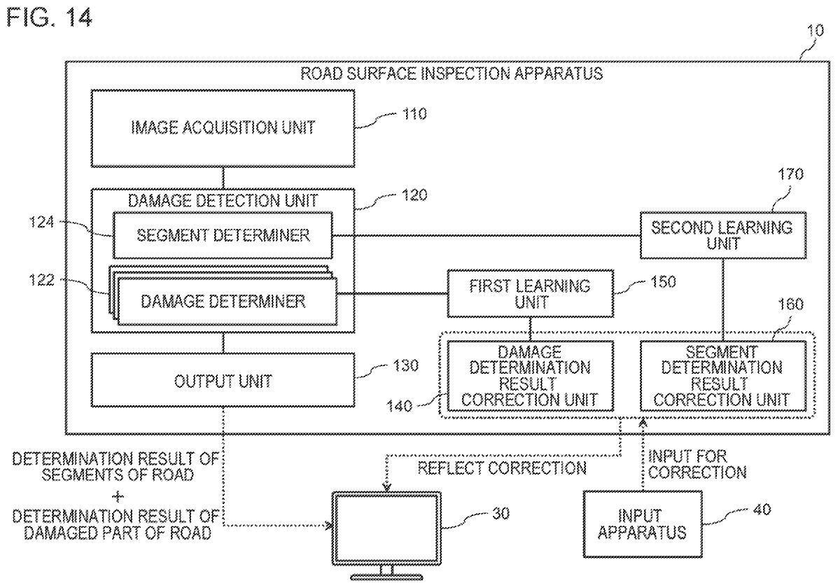

FIG. 14 is a diagram illustrating a functional configuration of a road surface inspection apparatus 10 according to the fourth example embodiment. As illustrated in FIG. 14, the road surface inspection apparatus 10 according to the present example embodiment further includes a segment determination result correction unit 160 and a second learning unit 170.

Based on an input for correction to a determination result of segments of a road by a segment determiner 124 (hereinafter also denoted as an “input for segment correction”), the segment determination result correction unit 160 corrects the determination result of segments of the road, the determination result being a target of the input for segment correction. Specifically, a person performing confirmation work of a screen (a screen displaying a segment determination result of a road by the segment determiner 124 and a determination result of a damaged part of the road by a damage determiner 122) output on a display apparatus 30 performs an input operation (input for segment correction) for correcting an erroneous determination result related to a segment of a road, the erroneous determination result being found on the screen, to a correct determination result by using an input apparatus 40. The segment determination result correction unit 160 accepts the input for segment correction through the input apparatus 40. Then, the segment determination result correction unit 160 corrects the erroneous determination result related to the segment of the road, based on the input for segment correction.

The second learning unit 170 generates training data for machine learning of the segment determiner 124 (second training data) by using an input for segment correction to a determination result by the segment determiner 124 and an input image. For example, the second learning unit 170 may extract a partial image region corresponding to a determination result being a target of an input for segment correction and generate second training data by combining the partial image region with a determination result indicated by the input for segment correction (a correct answer label indicating the type of road segment). Further, the second learning unit 170 may generate first training data by combining an input image acquired by an image acquisition unit 110 with a determination result of segments of a road by the segment determiner 124. In this case, the determination result of segments of the road by the segment determiner 124 may include a determination result corrected by the segment determination result correction unit 160 as a target of an input for segment correction and a determination result not being a target of the segment input for correction. Then, the second learning unit 170 performs learning (relearning) of the segment determiner 124 by using the generated second training data.

### <Flow of Processing>

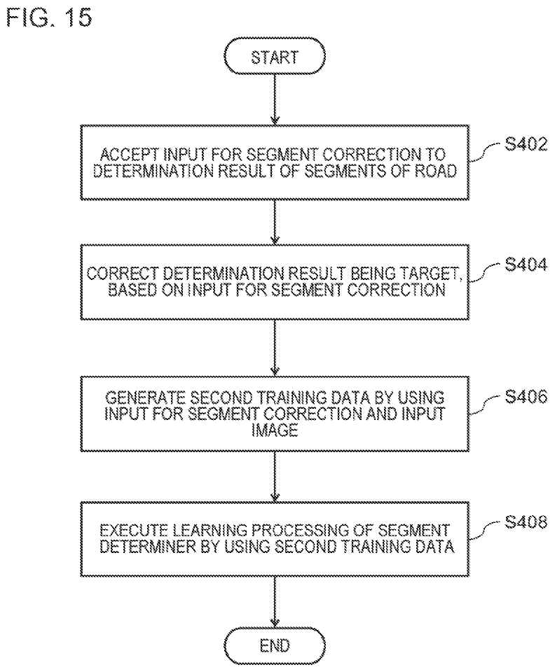

FIG. 15 is a flowchart illustrating a flow of processing executed by the road surface inspection apparatus 10 according to the fourth example embodiment. The processing described below is executed after output processing (such as the processing in S106 in FIG. 3) by an output unit 130.

First, the segment determination result correction unit 160 accepts an input for segment correction to a determination result of segments of a road by the segment determiner 124 (S402). The input for segment correction is performed by a person performing confirmation work of a screen displayed on the display apparatus 30, by using the input apparatus 40 such as a keyboard, a mouse, or a touch panel. Then, the damage determination result correction unit 140 corrects the determination result being a target of the input for segment correction, based on the input for segment correction (S404).

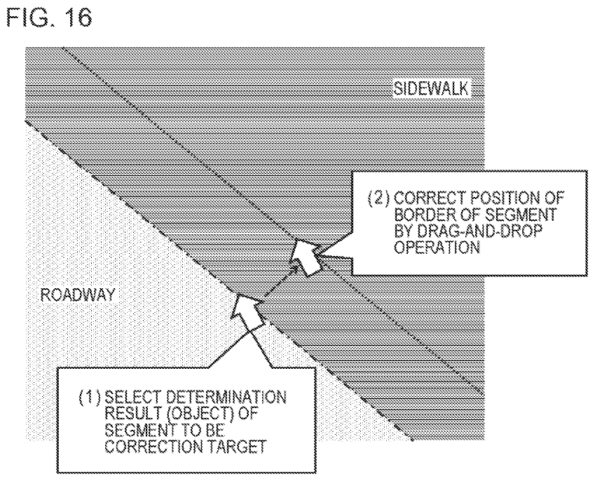

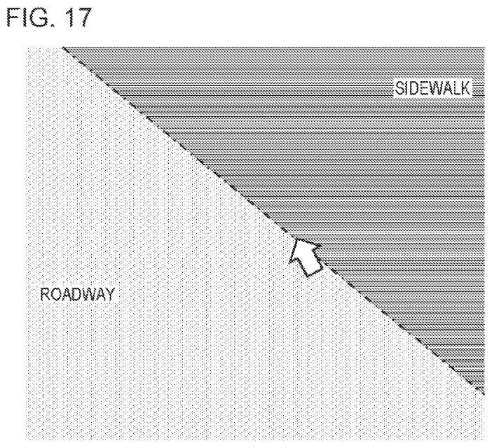

A specific example of operation of the segment determination result correction unit 160 will be described by using diagrams. FIG. 16 and FIG. 17 are diagrams illustrating a specific operation of the segment determination result correction unit 160. Note that the diagrams are strictly examples, and the operation of the segment determination result correction unit 160 is not limited to contents disclosed in the diagrams.

First, when an error is found in a determination result of segments of a road displayed on the display apparatus 30, information for correction to the determination result of segments is input by an operation as illustrated in FIG. 16. In the example in FIG. 16, as an operation of correcting the position of a border between segments of a “road” and a “sidewalk,” (1) the determination result of segments to be a correction target (an object drawn on the screen) is selected, and (2) an operation of correcting the border position of the selected segments of the road is executed by a drag-and-drop operation. In response to such an operation, the segment determination result correction unit 160 corrects the determination result related to the “roadway” segment (a region determined to be a “roadway” in the image) and the determination result related to the “sidewalk” segment (a region determined to be a “roadway” in the image), as illustrated in FIG. 17. Without being limited to the example in the diagrams, for example, the segment determination result correction unit 160 may be configured to provide a user interface enabling an input operation of transforming part of the shape or the border line of each segment, or an input operation of newly re-setting the shape or the border of a segment.

Returning to the flowchart in FIG. 15, the second learning unit 170 generates second training data by using the input for correction accepted in S402 and an input image acquired by the image acquisition unit 110 (S406). For example, the second learning unit 170 extracts a partial image region corresponding to the determination result being a correction target of the input for segment correction out of the input image and generates second training data by combining the partial image region or an image feature value of the partial image region with contents of the input for segment correction (information indicating the type of segment of the road). Then, the second learning unit 170 executes learning processing of the segment determiner 124 by using the generated second training data (S408). The second learning unit 170 may be configured to execute learning processing of the segment determiner 124 every time an input for segment correction is accepted. Further, the second learning unit 170 may be configured to accumulate second training data generated according to an input for segment correction into a predetermined storage region and execute learning processing using the accumulated second training data at a predetermined timing (such as a timing of periodic nighttime maintenance).

### Advantageous Effect

According to the present example embodiment, training data for the segment determiner 124 are generated according to an input for segment correction accepted by the segment determination result correction unit 160, and relearning of the segment determiner 124 is executed. Thus, precision in determination of segments of a road by the segment determiner 124 improves, and suitable inputs can be provided for a plurality of damage determiners 122 built especially for a plurality of segments, respectively. As a result, precision in detection of a damaged part of a road for each segment improves, and the number of appearances of a determination result with a low certainty factor (a determination result to be confirmed by the human) can be reduced. By reduction in the number of appearances of a determination result with a low certainty factor, further improvement in efficiency of the entire work can be expected. Further, work of correcting an erroneous determination of segments of a road made by the segment determiner 124 also serves as work of generating training data for machine learning, according to the present example embodiment. Therefore, learning data for the segment determiner 124 can be generated in confirmation work of an output by the output unit 130 without separately performing conventional work of generating learning data (work of manually associating learning image data with a correct answer label). Thus efforts made for improving precision of the segment determiner 124 and the damage determiner 122 can be reduced.

### Fifth Example Embodiment

A road surface inspection apparatus 10 according to the present example embodiment differs from that according to each of the aforementioned example embodiments in having a function of executing machine learning by generating training data of a damage determiner 122 by using a determination result of a road by the damage determiner 122.

### <Functional Configuration>

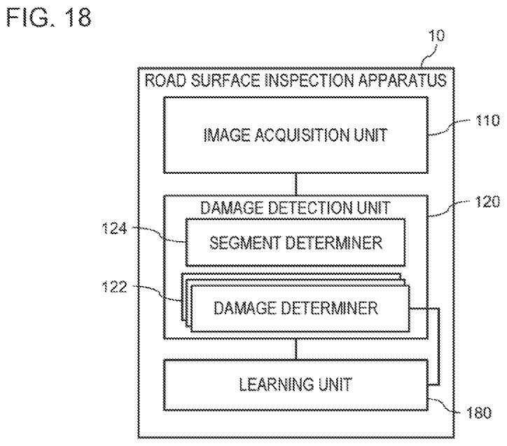

FIG. 18 is a block diagram illustrating a functional configuration of the road surface inspection apparatus 10 according to the fifth example embodiment. As illustrated in FIG. 18, the road surface inspection apparatus 10 according to the present example embodiment includes an image acquisition unit 110, a damage detection unit 120, and a learning unit 180.

The image acquisition unit 110 and the damage detection unit 120 have functions similar to those described in each of the aforementioned example embodiments. The damage detection unit 120 according to the present example embodiment includes a plurality of damage determiners 122 determining a damaged part of a road and a segment determiner 124 determining segments of a road. Further, each of the plurality of damage determiners 122 is related to each of a plurality of segments predefined for a road (for example, segments in a widthwise direction such as a “roadway,” a “shoulder,” and a “sidewalk,” and segments of road surface materials such as “asphalt” and “concrete”).

The learning unit 180 generates training data used for machine learning of a damage determiner 122 by using a determination result of a damaged part of a road by the damage determiner 122 and an input image. Then, by using the generated training data, the learning unit 180 executes machine learning of the damage determiner 122.

The learning unit 180 is configured to select a damage determiner 122 to be a target of machine learning using the generated training data, based on a determination result of segments by the segment determiner 124. As a specific example, it is assumed that the learning unit 180 acquires information indicating that the road surface material of a road is “asphalt” as a determination result of segments by the segment determiner 124. In this case, the learning unit 180 selects a damage determiner 122 related to the segment “asphalt” as a target of machine learning using the generated training data. Further, it is assumed that the learning unit 180 acquires information indicating that the segment in a widthwise direction of a road is a “roadway” as a determination result of segments by the segment determiner 124. In this case, the learning unit 180 selects a damage determiner 122 related to the segment “roadway” as a target of machine learning using the generated training data. Further, it is assumed that the learning unit 180 acquires information indicating that the road surface material of a road is “asphalt” and the segment in a widthwise direction of the road is the “roadway” as a determination result of segments by the segment determiner 124. In this case, the learning unit 180 selects a damage determiner 122 related to the segments “asphalt” and “roadway” as a target of machine learning using the generated training data. Such a configuration reduces the probability of a damage determiner 122 learning an erroneous feature value with training data (noise data) for a different segment. Consequently, decline in determination precision of the damage determiner 122 caused by machine learning can be prevented.

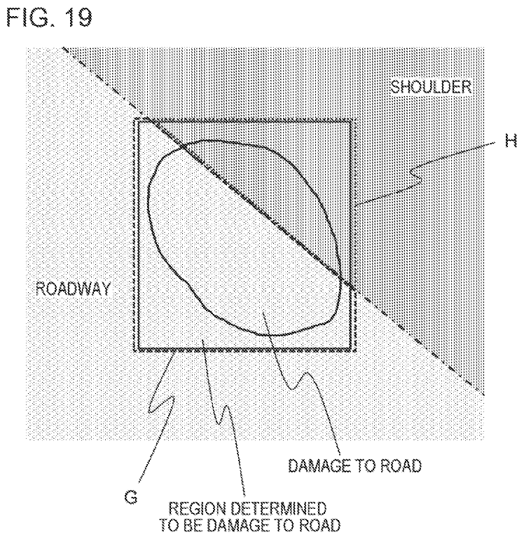

Further, a damaged part of a road may be positioned over two or more segments. For example, a crack of a road may extend from a roadway to a shoulder. In this case, the learning unit 180 may be configured to select a damage determiner 122 to be a target of machine learning, based on the size (the number of pixels) of damage to the road in each of two or more segments. For example, when half or more of a crack of a road extending over a road and a shoulder is positioned on the roadway side, the learning unit 180 selects a damage determiner 122 for a roadway as a target of machine learning using training data generated by using an image including the crack part of the road. As another example, the learning unit 180 may be configured to generate training data for each of two or more segments by using a damaged part of a road in each of the two or more segments. For example, when damage to a road is positioned over two segments being a road and a shoulder as illustrated in FIG. 19, the learning unit 180 may be configured to generate training data of a damage determiner 122 for a road by using an image region indicated by a character G (a region in broken lines in the diagram) and generate training data of a damage determiner 122 for a shoulder by using an image region indicated by a character H (a region in dotted lines in the diagram).

While the example embodiments of the present invention have been described with reference to the drawings, the example embodiments shall not limit the interpretation of the present invention, and various changes and modifications may be made based on the knowledge of a person skilled in the art without departing from the spirit of the present invention. A plurality of components disclosed in the example embodiments may form various inventions by appropriate combinations thereof. For example, several components may be deleted from all the components disclosed in the example embodiments, or components in different example embodiments may be combined as appropriate.

Further, while a plurality of steps (processing) are described in a sequential order in each of a plurality of flowcharts used in the aforementioned description, an execution order of steps executed in each example embodiment is not limited to the described order. An order of the illustrated steps may be modified without affecting the contents in each example embodiment. Further, the aforementioned example embodiments may be combined without contradicting one another.

The aforementioned example embodiments may also be described in whole or in part as the following supplementary notes but are not limited thereto.

1. A road surface inspection apparatus including:

an image acquisition unit that acquires an input image in which a road is captured;

a damage detection unit that detects a damaged part of the road in the input image by using a damage determiner being built by machine learning and determining a damaged part of a road; and

an output unit that outputs, out of one or more determination results of a damaged part of the road by the damage determiner, the determination result with a certainty factor equal to or less than a reference value in a state of being distinguishable from another determination result to a display apparatus.

2. A road surface inspection apparatus including:

an image acquisition unit that acquires an input image in which a road is captured;

a damage detection unit that detects a damaged part of the road in the input image by using a damage determiner being built by machine learning and determining a damaged part of a road; and

an output unit that outputs, to a display apparatus, a determination result of a damaged part of the road by the damage determiner along with a certainty factor of the determination result.

3. The road surface inspection apparatus according to 1. or 2., further including

a damage determination result correction unit that corrects, based on an input for correction to a determination result of a damaged part of a road, the determination result being output to the display apparatus, a determination result being a target of the input for correction.

4. The road surface inspection apparatus according to 3., further including

a first learning unit that generates first training data by using the input for correction and the input image and performs learning of the damage determiner by using the first training data.

5. The road surface inspection apparatus according to any one of 1. to 4., wherein

a plurality of segments are defined for a road, and

the damage detection unit detects a damaged part of a road for each of the plurality of segments by using the damage determiner built for each of the plurality of segments.

6. The road surface inspection apparatus according to 5., wherein

the damage detection unit determines a region corresponding to each of the plurality of segments in the input image by using a segment determiner being built by machine learning and determining a region corresponding to each of the plurality of segments, and

the output unit further outputs, to the display apparatus, a determination result of the plurality of segments by the segment determiner.

7. The road surface inspection apparatus according to 6., further including

a segment determination result correction unit that corrects, based on an input for segment correction to a determination result of the plurality of segments, the determination result being output to the display apparatus, a determination result being a target of the input for segment correction.

8. The road surface inspection apparatus according to 7., further including

a second learning unit that generates second training data by using the input for segment correction and the input image and performs learning of the segment determiner by using the second training data.

9. A road surface inspection method including, by a computer:

acquiring an input image in which a road is captured;

detecting a damaged part of the road in the input image by using a damage determiner being built by machine learning and determining a damaged part of a road; and

outputting, out of one or more determination results of a damaged part of the road by the damage determiner, the determination result with a certainty factor equal to or less than a reference value in a state of being distinguishable from another determination result to a display apparatus.

10. A road surface inspection method including, by a computer:

acquiring an input image in which a road is captured;

detecting a damaged part of the road in the input image by using a damage determiner being built by machine learning and determining a damaged part of a road; and

outputting, to a display apparatus, a determination result of a damaged part of the road by the damage determiner along with a certainty factor of the determination result.

11. The road surface inspection method according to 9. or 10., further including, by the computer,

based on an input for correction to a determination result of a damaged part of a road, the determination result being output to the display apparatus, correcting a determination result being a target of the input for correction.

12. The road surface inspection method according to 11., further including, by the computer,

generating first training data by using the input for correction and the input image and performing learning of the damage determiner by using the first training data.

13. The road surface inspection method according to any one of 9. to 12., wherein

a plurality of segments are defined for a road,

the road surface inspection method further including, by the computer,

detecting a damaged part of a road for each of the plurality of segments by using the damage determiner built for each of the plurality of segments.

14. The road surface inspection method according to 13., further including, by the computer:

determining a region corresponding to each of the plurality of segments in the input image by using a segment determiner being built by machine learning and determining a region corresponding to each of the plurality of segments; and

further outputting, to the display apparatus, a determination result of the plurality of segments by the segment determiner.

15. The road surface inspection method according to 14., further including, by the computer,

based on an input for segment correction to a determination result of the plurality of segments, the determination result being output to the display apparatus, correcting a determination result being a target of the input for segment correction.

16. The road surface inspection method according to 15., further including, by the computer,

generating second training data by using the input for segment correction and the input image and performing learning of the segment determiner by using the second training data.

17. A program for causing a computer to execute the road surface inspection method according to any one of 9. to 16.
18. A road surface inspection apparatus including:

an image acquisition unit that acquires an input image in which a road is captured;

a damage detection unit that detects a damaged part of the road from the input image by using a damage determiner being built by machine learning and determining a damaged part of a road; and

a learning unit that generates training data used for machine learning of the damage determiner by using the input image and a determination result of a damaged part of the road and performing learning of the damage determiner by using the generated training data, in which

the damage determiner is built for each of a plurality of segments related to a road,

the damage detection unit
determines a segment related to a road captured in the image out of the plurality of segments, based on the input image, and
detects a damaged part of a road by using the damage determiner related to the determined segment, and

the learning unit
selects a damage determiner to be a target of the learning, based on a determination result of the segment by the damage detection unit.
   19. The road surface inspection apparatus according to 18., in which,

when a damaged part of the road is positioned over two or more segments out of the plurality of segments, the learning unit selects a damage determiner to be a target of the learning, based on a size of a damaged part of the road in each of the two or more segments.

20. The road surface inspection apparatus according to 18., in which,

when a damaged part of a road is positioned over two or more segments out of the plurality of segments, the learning unit generates training data of a damage determiner related to each of the two or more segments by using a damaged part of the road in each of the two or more segments.

What is claimed is:

1. A road surface inspection apparatus comprising:
an image acquisition unit that acquires an input image in which a road is captured;
a damage detection unit that detects a damaged part of the road in the input image by using a damage determiner being built by machine learning and determining a damaged part of a road; and
an output unit that outputs, out of one or more determination results of a damaged part of the road by the damage determiner, the determination result with a certainty factor equal to or less than a reference value in a state of being distinguishable from another determination result to a display apparatus.

2. (canceled)

3. The road surface inspection apparatus according to claim 1, further comprising
a damage determination result correction unit that corrects, based on an input for correction to a determination result of a damaged part of the road, the determination result being output to the display apparatus, a determination result being a target of the input for correction.

4. The road surface inspection apparatus according to claim 3, further comprising
a first learning unit that generates first training data by using the input for correction and the input image and performs learning of the damage determiner by using the first training data.

5. The road surface inspection apparatus according to claim 1, wherein
a plurality of segments are defined for a road, and
the damage detection unit detects a damaged part of a road for each of the plurality of segments by using the damage determiner built for each of the plurality of segments.

6. The road surface inspection apparatus according to claim 5, wherein
the damage detection unit determines a region corresponding to each of the plurality of segments in the input image by using a segment determiner being built by machine learning and determining a region corresponding to each of the plurality of segments, and
the output unit further outputs, to the display apparatus, a determination result of the plurality of segments by the segment determiner.

7. The road surface inspection apparatus according to claim 6, further comprising
a segment determination result correction unit that corrects, based on an input for segment correction to a determination result of the plurality of segments, the determination result being output to the display apparatus, a determination result being a target of the input for segment correction.

8. The road surface inspection apparatus according to claim 7, further comprising
a second learning unit that generates second training data by using the input for segment correction and the input image and performs learning of the segment determiner by using the second training data.

9. A road surface inspection method comprising, by a computer:
acquiring an input image in which a road is captured;
detecting a damaged part of the road in the input image by using a damage determiner being built by machine learning and determining a damaged part of a road; and
outputting, out of one or more determination results of a damaged part of the road by the damage determiner, the determination result with a certainty factor equal to or less than a reference value in a state of being distinguishable from another determination result to a display apparatus.

10. (canceled)

11. A non-transitory computer readable mediums storing a program for causing a computer to execute a road surface inspection method, the method comprising:
acquiring an input image in which a road is captured;
detecting a damaged part of the road in the input image by using a damage determiner being built by machine learning and determining a damaged part of a road; and
outputting, out of one or more determination results of a damaged part of the road by the damage determiner, the determination result with a certainty factor equal to or less than a reference value in a state of being distinguishable from another determination result to a display apparatus.
